(19) United States
(12) Patent Application Publication
(10) Pub. No.: US 2017/0110214 A1
(43) Pub. Date: Apr. 20, 2017

(54) PLASTIC FIBRE WITH ELECTRICAL CONDUCTIVITY

(71) Applicant: FEEGOO LIZENZ GMBH, Kiel (DE)

(72) Inventor: Edgar Johannes VAN HATTUM, Bergen (DE)

(21) Appl. No.: 15/129,214

(22) PCT Filed: Mar. 26, 2015
(86) PCT No.: PCT/DE2015/000153

§ 371 Date: Nov. 16, 2016

(30) Foreign Application Priority Data
Mar. 26, 2014 (DE) 10 2014 004 592.7

(51) Int. Cl. H01B 1/22; C08K 3/32; D01F 1/09; H01F 1/01; D01F 6/62

(52) U.S. Cl. CPC H01B 1/22; H01F 1/015; D01F 6/62; D01F 1/09; C08K 3/32; C08K 2201/001; C08K 2201/01

(57) ABSTRACT

A system having preclinical emergency care modules which produce a complex condition-dependent control system that is as integral as possible in combination with a human emergency worker. At the system level, an intelligent decision-making system is provided which leads to measures that are optimized for the situation with and without the emergency worker. The modules exhibit a different behavior depending on the situation and interaction. In the process, the emergency worker can be utilized as an additional sensor/actuator module. Based on all obtained sensor data, which is weighted differently, decision-making support is proposed to the emergency worker, or the system. makes decisions automatically. The protected communication of the modules is of particular importance for this purpose.

The invention relates to an electrically conductive polymeric fiber, wherein the fiber material is formed by a base material composed of PET, with elements intercalated therein.

It has been known in the art for some time that plastics or plastic composite materials can be used for various technical applications, for example as base material for items of clothing, as insulation material, etc. One of these types of plastic used on a large scale is polyethylene terephthalate (PET). This PET polymer is a thermoplastic polymer from the family of the polyesters which is prepared by polycondensation.

PET has a polar base structure and has strong intramolecular forces. PET molecules are additionally linear, i.e. formed without crosslinking. Because of the polar linear structure, PET is characterized by semicrystalline regions and fibers, which cause a high fracture resistance and dimensional stability even in temperature ranges above 80° C. Thus, PET as a material is generally also suitable for these temperature ranges.

PET materials are prepared from monomers such as terephthalic acid (benzenedicarboxylic acid) and ethylene glycol (dihydroxyethane or ethanediol). In order to be able to produce an ounce of relevance for industrial applicability, the industrial scale preparation is effected by transesterification of diethyl terephthalate with ethanediol. This equilibrium reaction gives rise to an unwanted additional amount of ethanediol, or it is required for the reaction that this substance be distilled off again by virtue of the reaction regime, in order to have a favorable influence on the equilibrium. The alternative possibility of melt phase polycondensation is unsuitable for the production of large volumes, because this form of production takes excessively long periods of time. In order to achieve high PET quality, depending on the desired end use, there is a downstream solid phase condensation in order to achieve further condensation. A further known way of preparing PET involves the esterification of ethanediol with terephthalic acid.

In general, PET molecules are one chain structures consisting predominantly of carbon, hydrogen and a few other atoms. The molecules have a spiral to entangled arrangement. The effect of this is that, especially in the amorphous state, a multitude of empty spaces are available in the atomic region between the molecules. An axial or biaxial orientation of the material can reduce the size of these empty spaces, which leads, for example, to higher strength of the material and to reduced gas permeability.

As well as the use of PET in pure form, the prior art also discloses the material modification thereof. As base material for composite materials, it is possible to add other elements to the thermoplastic polymer. In the pure state, PET is essentially an electrical insulator. By intercalation, for example, of metallic atoms into the empty spaces between the molecules or by addition of metallic atoms, for example, onto the PET molecules, it is possible to impart electrically conductive properties to the material to a certain degree. Correspondingly metal-doped PET fibers thus conduct electrical current application of a voltage.

In addition, it is known that various, probably metallic materials, for example alloys comprising gadolinium or other rare earth metals, have a magnetocaloric effect. The magnetocaloric effect heats the material when it is subjected and cools it down again when the effect of the magnetic field has ended. The cause of this heating reaction is the alignment of the magnetic moments of the material by the magnetic field and their dependence on the magnetic field strength. The speed of alignment of the magnetic moments gives rise to heat. One possible application could be used as a coolant, in that periodic magnetization and simultaneous removal of the resultant can achieve a cooling effect.

The magnetocaloric effect is highly afflicted by hysteresis, depending on the alloy. In order to achieve the magnetocaloric effect in connection with applications which entails possibly additive mechanical stress as well, there is a search for alloys which combine these physical effects and properties. A further problem with the technical application of this effect, as well as the unwanted hysteresis characteristics, is the fact that this effect in the case of known alloys and material compositions has to date been comparatively weak.

The skin effect, also called current displacement, is an effect in electrical conductors through which relatively high-frequency alternating current flows, the result of which is that the current density within a conductor is lower than in the outer regions. It occurs in thick conductors relative to the skin depth and also in the case of electrically conductive shields and cable shields. With increasing frequency, the skin effect promotes the transfer impedance of shielded cables and the shielding attenuation of conductive shields, but increases the resistance per unit length of article cable. This means in practical terms that the skin depth, i.e. the conducting layer thickness, decreases with increasing alternating current frequency depending on the material. As a result of high alternating current frequencies of more than 100 kHz within a copper conduit, a skin depth of 0.21 mm is present.

It is an object of the present invention to provide a fiber of the type specified by way of introduction, such that an exactly defined emission and/or absorption of radiant energy and inexpensive production is possible.

This object is achieved in accordance with the invention by forming a base material component by means of PET to which properties are imparted by means of suitable doping elements.

The doping elements may additionally impart the ability to at least partly conduct electrical energy to the PET material.

The doping elements firstly generate properties as an absorber for radiant energy, and they can secondly generate properties as an electrical conductor. The intercalation of metallic atoms, for example, into the empty spaces between the molecules or an addition of metallic atoms, for example, onto the PET molecules can impart electrically conductive properties to the PET material to a certain degree.

Correspondingly metallically doped PET fibers thus conduct an electrical current application of a voltage. According to the electrical resistance of this composite material, it generates or absorbs radiation depending on the current applied. The effects are promoted depending on the above-described skin effect and by additive absorption of radiant energy. This means that the PET composite material of the invention constitutes a novel material alternative for the absorption of radiation or generation of radiation to the known metal fiber materials.

In addition, the mechanical properties of the PET, in terms of its fracture resistance and dimensional stability, even in temperature ranges above 80° C., are utilized in order to open up fields of application with these elevated mechanical demands to the absorber material.

A further property of the absorber material of the invention is its property, depending on the respective doping elements, of being at least partly electrically conductive. Especially when the PET composite material constitutes a base material for some kind of heat source, the physical effects of the absorption capacity and electrical conductivity can be combined for the increase in the amount of heat to be released, and hence increased by additionally generating heat energy by an electrical route in addition to the heat radiation emitted on the basis of the absorption of radiation by means of a voltage applied to the PET composite material as a result of the electrical resistance of the material.

A further application of interest for the PET composite material is opened up by its property of achieving the magnetocaloric effect and simultaneously of having the mechanical material properties inherent to the PET. By means of suitable doping elements, it is thus also possible to impart cooling action properties to the material of the invention.

It is recognized by the teaching of the invention that the elements suitable for the PET doping are especially MnFe-phosphorus compounds, MnFe(As,PwGexSiz)s; FeMn-phosphorus compounds with As,Si-phosphorus substitution, optionally combined with La(FeMnP)AlCo; compounds comprising Mn—Zn.

A preferred application lies in the use of the doping structural formula MnFe(As,PwGexSiz)s. This compound has high cooling capacities at temperatures of 200 to 600 K, especially at 280 to 500 K. This compound exhibits a very strong magnetocaloric effect. The use of this compound is environmentally friendly because of the fact that the substances that are problematic in environmental terms, especially the Mn molecules, are bound within the PET base matrix. Very efficient properties are achievable when x=0.3−0.7 and/or w is not more than 1−x and z=1−x−w in the structural compound thereof. Preferably, in this specific version, the material is realized in a hexagonal structuring of the Fe2P—.

The various material compositions can be produced in a ball mill and under a protective gas atmosphere.

An alloy of 5 g of FeMnP0.7Ge0.3 with a critical temperature of about 350 K can be produced, for example, by mixing the pure elements having a quality of 3N, in the following amounts: FeMnP0.7Ge0.3. In a closed ball mill, these elements are ground under a protective atmosphere until an amorphous or microcrystalline product is obtained. According to the properties of the mill, such a product can be obtained within 20 minutes up to a few hours. Thereafter, the powder is heated in a closed ampoule in a protected atmosphere until a temperature of about 800 to 1050 degrees C. is attained. Thereafter, it is heated to a temperature of about 650 degrees C. The alloy crystallizes in a hexagonal Fe2P structure.

An alloy of 5 g of FeMnP0.5Ge0.5 with a critical temperature of about 600 K is prepared by mixing the pure elements having a quality of 3N in the following amounts: Fe=1.72 g, Mn=1.69 g, P=0.476 g and Ge=1.12 g. In a closed ball mill, these elements are ground under a protective atmosphere until an amorphous or microcrystalline product is obtained. According to the properties of the mill, such a product can be obtained within 20 minutes up to a few hours. The powder is then heated in a closed ampoule in a protected atmosphere until a temperature of about 800 to 1050 degrees C is attained. Thereafter, it is heated to a temperature of about 650 degrees C.

The alloy likewise crystallizes in a hexagonal Fe2P structure.

An alloy of 5 g of FeMnP0.5Ge0.1Si0.4 with a critical temperature of about 300 K is produced by mixing the pure elements having a quality of 3N in the following amounts: Fe=1.93 g, Mn=1.90 g, P=0.535 g, Ge=1.251 g and Si=0.388 g. In a closed ball mill, these elements are ground under a protective atmosphere until an amorphous or microcrystalline product is obtained. According to the properties of the mill, such a product can be obtained within 20 minutes up to a few hours. The powder is then heated in a closed ampoule in a protected atmosphere until a temperature of about 800 to 1050 degrees C. is attained. Thereafter, it is heated to a temperature of about 650 degrees C. The alloy likewise crystallizes in a hexagonal Fe2P structure.

An alternative execution is obtained via polymorphs of alloys of the starting materials rather than the pure elements - this is particularly advantageous when Si is being used in the alloy. This is based on the fact that FeSi alloys are very stable and are obtained when pure Fe and Si are available in the mill.

An alloy of 10 g of Fe0.86Mn1.14P0.5Si0.35Ge0.15 having a critical temperature of 390: is obtained by mixing the pure elements having a quality of 3N, and the alloy Fe2P having a quality of 2N (Alpha Aesar 22951), in the following amounts: Fe2P=4.18 g, Mn=4.26 g, P=0.148 g, Si=0.669 g and Ge=0.742 g.

In a closed ball mill, these elements are ground under a protective atmosphere until an amorphous or microcrystalline product is obtained. According to the properties of the mill, such a product can be obtained within 20 minutes up to a few hours. The powder is then heated in a closed ampoule in a protected atmosphere until a temperature of about 800 to 1050 degrees C. is attained. Thereafter, it is heated to a temperature of about 650 degrees C. The present invention is not restricted to the execution described by way of example. The amounts can be varied in various ways.

The drawings show the effects underlying the invention and working examples of the internal structure of the material in schematic form. The figures show:

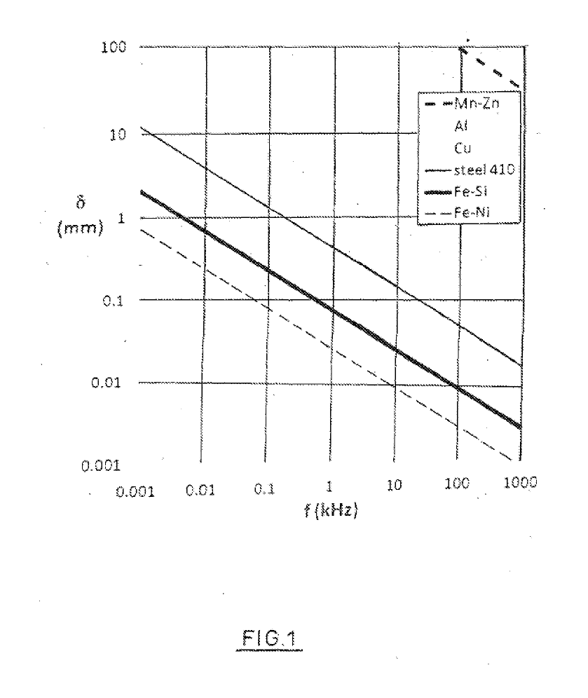

FIG. 1 the physical skin effect in diagrammatic form, i.e.

the equivalent conductive layer thickness 5 in mm of various metals versus the alternating current frequency f in kHz

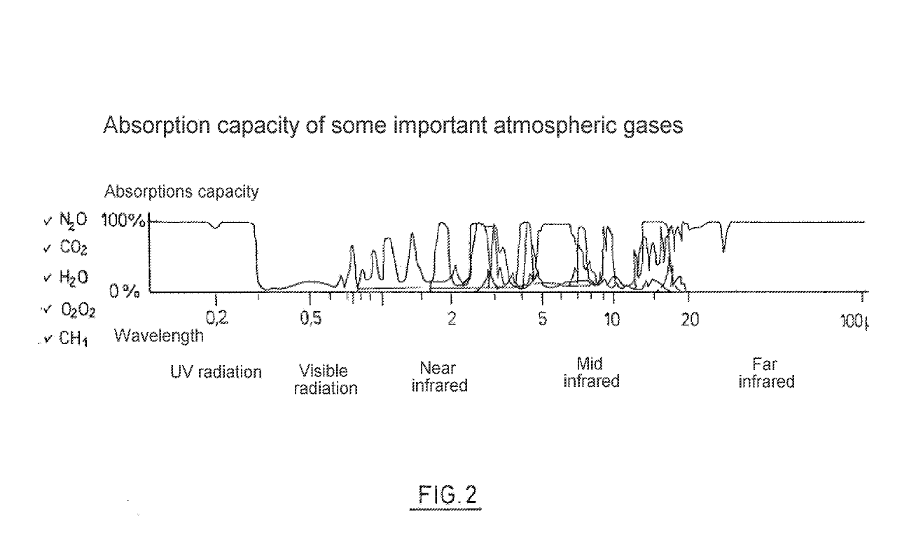

FIG. 2 in a collated diagram, the absorption characteristics of various atmospheric gases as a function of wavelength

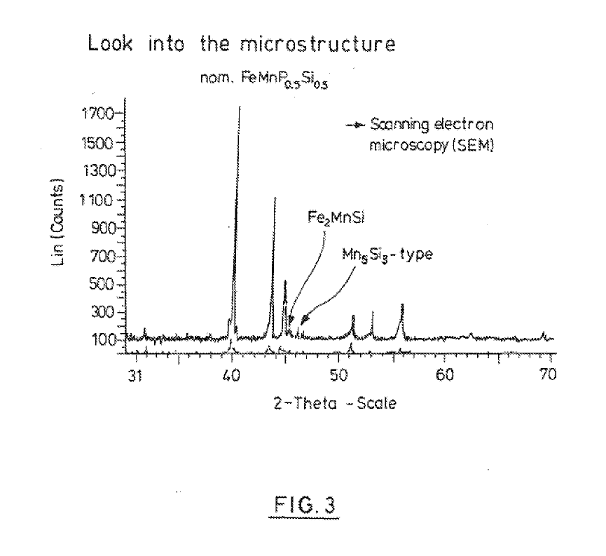

FIG. 3 the microstructure of FeMnP0.5Si0.5,

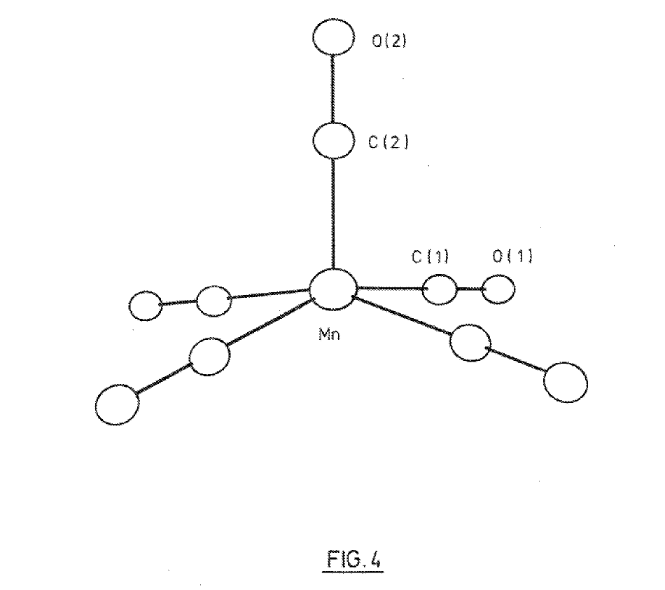

FIG. 4 in a perspective view, the structure of Mn(CO)5J anions,

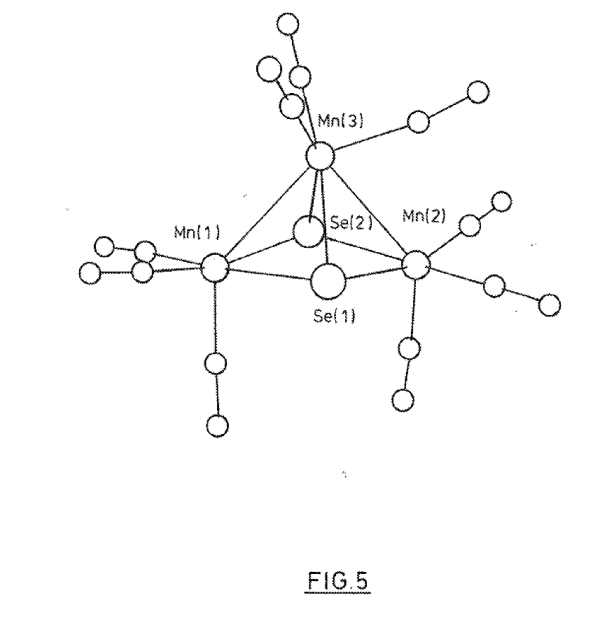

FIG. 5 in a perspective view, the structure of [Mn3Se2(CO)9],

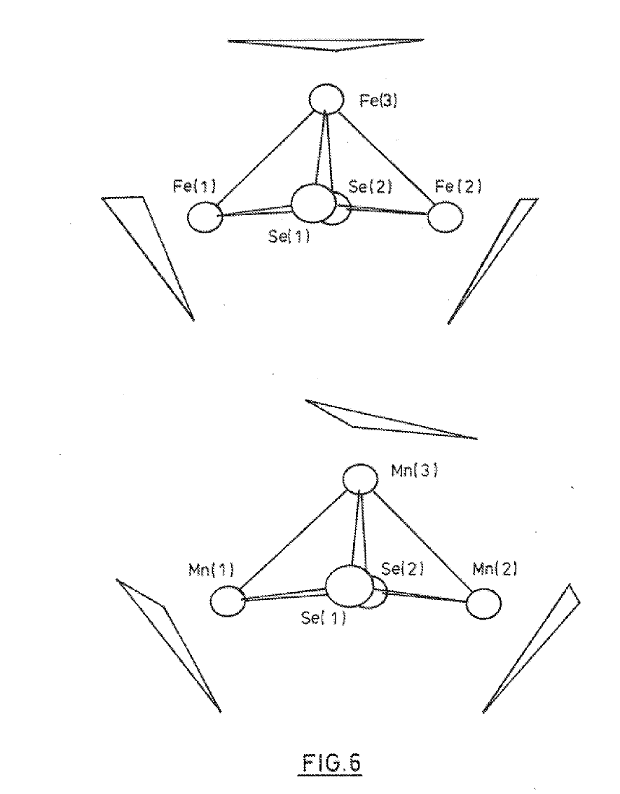

FIG. 6 in a perspective view, in the upper diagram, the structure of the compound [Fe3Se2(CO)9] and, in the lower diagram, the structure of the compound [Mn3Se2(CO)9]2-anion. The representation of the CO groups has been omitted. The planes formed by the carbon atoms of each Mn atom are indicated by solid lines,

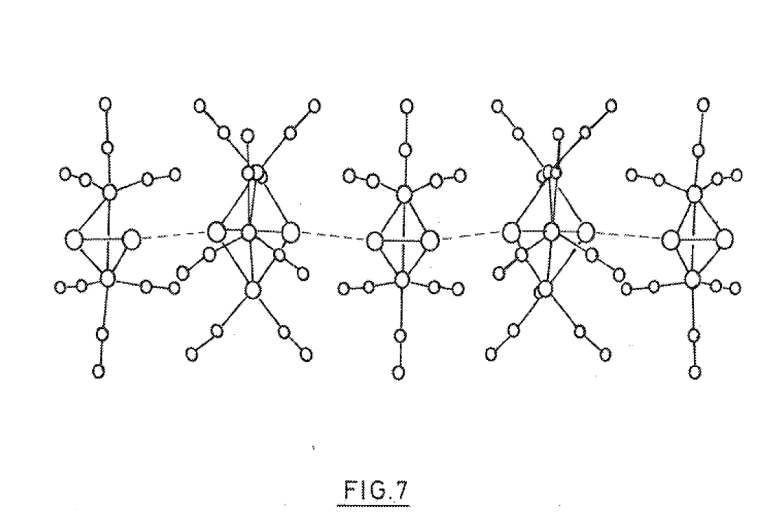

FIG. 7 in a perspective view, part of an alternating chain of trinuclear [Fe352(CO)9]- and dinuclear [Fe2(52) (CO)6],

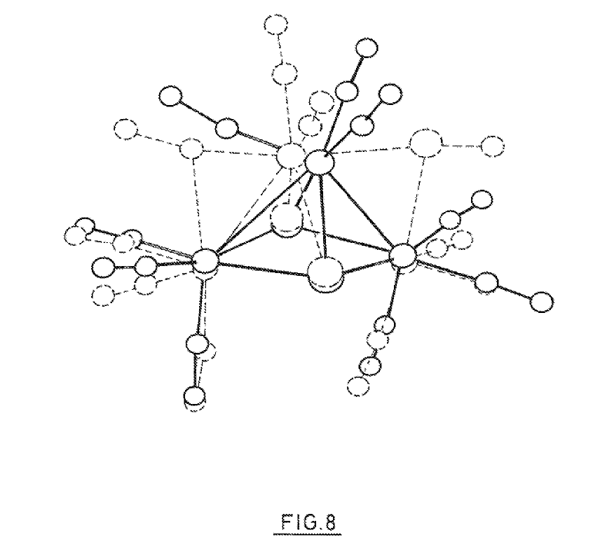

FIG. 8 in a perspective view, the superimposition of the structures of [Mn3Se2(CO)9]2- (shown in bold) and [Mn3Se2(SeMe3) (CO)9]2- (shown as a dotted line) (9), which form a complete 2-my carbon bridge,

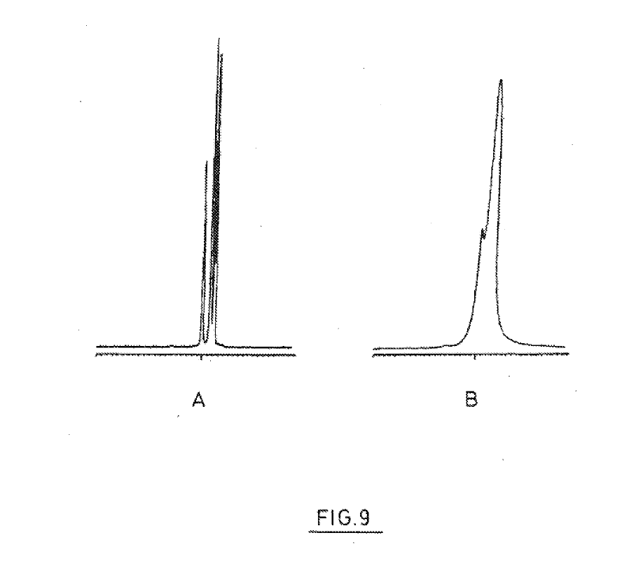

FIG. 9 in diagrammatic form, the 1H NMR absorption characteristics of Ph protons in [Ph4P]2[Mn3Se2(CO)9] (in the left-hand part A of the figure) and [Ph4P]2[Mn3Se2(CO)9] (in the right-hand part B of the figure).

FIG. 1 shows the physical effect of current displacement in near-surface boundary layers of a conductor through which current is flowing in diagrammatic form, i.e. the equivalent conducting layer thickness 5 in mm for various metals versus the alternating current frequency f in kH.

FIG. 2 illustrates, in a collated diagram, the absorption characteristics of various atmospheric gases as a function of wavelength.

FIG. 3 shows the known microstructure of FeMnP0.5Si0.5.

FIG. 4 shows, in a schematic diagram, the structure of Mn(CO)5J anions. In the crystalline structure of [Ph4P][Mn(CO)5], the charges of the mononuclear ionic complex [Mn(CO)5] are compensated for by tetraphenyl-phosphonium cations. The crystal complex consisting of an Mn particle in the middle having five bonds each to one C and one 0 particle is of a tetrahedral arrangement. Typical bond lengths and bond angles between the particles are compiled in the following table:

TABLE 15.1B
Distances [A] and angles [*] in a [Mn (CO) 5]-anion

| Distances: | | Angles: | |
|---|---|---|---|
| Mn—C(1) | 1.809(2) | C(1)—Mn—C(2) | 102.6(1) |
| Mn—C(2) | 1.794(3) | C(1)—Mn—C(1a) | 154.7(1) |
| | | C(1)—Mn—C(1b) | 87.3(1) |
| C(1)—O(1) | 1.159(2) | Mn—C(1)—O(1) | 179.5(2) |
| C(2)—O(2) | 1.155(4) | Mn—C(2)—O(2) | 180.0(1) |

* Symmetry transformation:
(a), ½ − X, ½ − y, z
(b), ½ − y, x, z
(c), 3/2 − xs, ½ − y, z
(d), ½ + y, 1 − y, 1 − z

The structural similarities of Mn(CO)5J anions and [HMn(CO)5] are to be observed. The synthesis and structural analysis of the Mn(CO)5J anions confirms that the energy barrier between square-pyramidal and trigonal-bipyramidal arrangements of the ligands in MLS complexes is very small. This type of complexes of stereochemically non-rigid geometry, as a result of which, for example, another counterion is present, can cause a change in the arrangement of the ligands. It is thus remarkable that, in spite of the low energy barrier, only the [Mn(CO)5] anions have to date been the sole example of the presence of two geometric isomers of [M(CO)5] n complex. The angles within the [Mn(CO)5] anion arrangement are listed in the abovementioned table.

FIG. 5 shows, in a perspective view, the structure of [Mn3Se2(CO)9]. The results of an x-ray structure analysis show that crystals of [Ph4P]2[Mn3Se2(CO)9], in addition to the mixed-valence trinuclear [Mn3Se2(CO)9]2 ion in the complex, contain THF molecules in a ratio of 2:1.

The heavy atom structure of [Mn3Se2(CO)9] is a slightly distorted square pyramid with an alternating arrangement of Mn and Se atoms in the surface region and a third Mn atom at the tip. Here, the environment for each of the Mn atoms is consolidated by the two Se atoms and three carbon ligands. A peculiarity in the arrangement of the carbon groups is possessed by the Mn atom at the tip of the pyramid.

One of the Mn . . . C distances are unexpectedly long, whereas, in the corresponding carbon group, the bonds are inclined, particularly in the direction of the adjacent Mn atoms. In the form of this feature, a new type of asymmetric carbon bridges is realized. While the heavy atom skeleton [M3Se2] in the same compound is possessed in isoelectronic form by iron complex [Fe3Se2(CO)9], the two compounds differ in the arrangement of the carbon ligands relative to the metal atom M3Se2 in the tip of the pyramid.

It is apparent that an electronic anti-valence of Mn(1) and Mn(2) leads to the fact that an asymmetric carbon bridge C(7) is formed between Mn(2) and Mn(3). The electronic inequivalence of Mn atoms is particularly obvious when the corresponding Mn-Se bond lengths (Mn(1) 2.458(2) or 2439(2), Mn(2): 2407(2) and 2.402(2) angstroms) are taken into account. This can be explained on the basis of the different oxidation states of manganese atoms, the common average of which is 0.67.

If the observed bond lengths and coordination numbers are now taken into account, one has the atoms Mn(2) and Mn(3) the oxidation state 1 and they are assigned, whereas results for Mn(1) gives a value of ±0. The molecule has point symmetry, with the manganese centers in the mirror plane. If the weak interaction of the asymmetric bridge (Mn(2)-C(7) 2726(7)) is neglected, it is found that all three Mn atoms a square-pyramidal geometry of three carbon and selenium surrounds two ligands. In this consideration, Mn(2) has a distorted octahedral ligand environment.

By contrast with the square-pyramidal coordinations of the manganese centers, the coordinations of Fe(3) are in 6-trigonal bipyramidal form.

The arrangement of the carbon ligands with respect to Fe(3) is in such a manner that Fe(1) and Fe(2) are surrounded. They are chemically equivalent and have about the same length of iron-selenium bonds (Fe(1): 2.351(1) 2.359(1), Fe(2): 2.354(1) 2.358(1) angstroms). The molecular symmetry Cs with the mirror plane now runs through the two selenium atoms and Fe(3). In the mixed-valence compound 6, Fe(3) has the +2 oxidation state, whereas Fe(1) and Fe(2) are formally +1.

The material presented here proceeds from the assumption that, in complexes of the [M3X2(COl )9]z (X=S, Se, Te, z=−2, −1, 0, +1)/5a-e/ type, an asymmetric carbon bridge is formed when the two metal atoms at the base of the pyramidal M3X2 are not electronically equivalent. Here, the more highly oxidized metal center is stabilized by the bridge, optionally by an interaction. The transition is non-equivalent. Here, the more highly oxidized metal center is stabilized by the bridge, optionally by an interaction.

The transition from the non-bridged to the bridged form is assigned with a 30 degree rotation of the apical M(CO)3 about its axis of symmetry and subsequent tilting by 15 degrees in the M(2) direction. At the same time, there is a change from trigonal-pyramidal to the square-pyramidal coordination.

FIG. 6 shows, in a perspective view, in the upper diagram, the structure of the compound [Fe3Se2(CO)9] and, in the lower diagram, the structure of the compound [Mn3Se2(CO)9]2- anion. The representation of the CO groups has been omitted. The planes formed by the carbon atoms of each Mn atom are indicated by solid lines. Selected bond lengths and bond angles between the particles of the [Mn3Se2(CO)9]2- anion are compiled in the following table:

| Distances: | | Angle | |
|---|---|---|---|
| Mn(1)—Se(1) | 2.407(2) | Se(1)—Mn(1)—Se(2) | 82.5(1) |
| Mn(1)—Se(2) | 2.402(2) | Se(1)—Mn(2)—Se(2) | 80.7(1) |
| Mn(2)—Se(1) | 2.458(2) | Se(1)—Mn(2)—Se(2) | 80.9(1) |
| Mn(2)—Se(2) | 2.439(2) | Middle figures | 81.3 |
| Mn(3)—Se(1) | 2.446(2) | | |
| Mn(3)—Se(2) | 2.444(2) | | |
| Average: | 2.432 | | |
| Mn(1)—Mn(2) | 3.647(2) | Mn(1)—Mn(3)—Mn(2) | 82.6(1) |
| Mn(1)—Mn(2) | 2.803(3) | Mn(1)—Mn(2)—Mn(3) | |
| Mn(1)—Mn(2) | 2.724(2) | Mn(2)—Mn(1)—Mn(3) | |
| Se(1) . . . Se(2) | 3.171(2) | | |
| Mn(2)—C(4) | 1.805(8) | Mn(2)—C(4)—O(4) | 176.8(1) |
| Mn(2)—C(5) | 1.803(6) | Mn(2)—C(4)—O(4 | 176.6(1) |
| Mn(2)—C(6) | 1.769(9) | Mn(2)—C(4)—O(4 | 176.0(1) |
| Mn(3)—C(7) | 1.783(8) | Mn(3)—C(7)—O(7) | 176.5(1) |
| Mn(3)—C(9) | 1.794(7) | Mn(3)—C(9)—O(9) | 171.0(1) |
| Mn(2)—C(7) | 2.726(7) | | |

[MnFe25e2(CO)9]- compared with [Mn3Se2(CO)9]2

A related compound with mixed metal complex [MnFe25e2(CO)9]-/3e/ was synthesized and described as being isostructural with [Fe3Se2(CO)9]/Sb/, used. The structural analysis was conducted on the basis of an unordered model in which two of the three metal centers are populated statistically by Mn and Fe. The problem of the Fe/Mn distribution in the complex [MnFe25e2(CO)9]- is the task in order to achieve the above-described results. This compound should be isostructural with 6.

The structure can be better described if the presence of an asymmetric carbon bridge is assumed. The [MnFe25e2(CO)9] anion carbon bridge is therefore not bound as 6, but is constructed more like [Mn3Se2(CO)9].

Taking account of the individual metal selenium, the distances thereof show that the positions of the metal atoms in the base of the M35e2 pyramid are in all probability not populated statistically but in an orderly manner by manganese (position M(1)) and iron (position M(2)). Here, the formally more highly oxidized metal atom (Mn here) is stabilized by the asymmetric carbon bridge in accordance with the hypothesis formulated above.

[Fe352(CO)9][Fe2(52) (CO)6], compared with [Mn35e2(CO)9]2

Even though asymmetric carbon bridges are very widespread in chemistry, there are only very few examples of the [MnFe25e2(CO)9]2 anion, a form identified with Mn for an unexpectedly long period. An essential, hitherto undiscovered asymmetric bridge of this kind can be found in the [Fe352(CO)9] unit complex. The property can also be found in [Fe352 (CO) 9][Fe2 (52) (CO)6]. This is surprisingly typical of a long M . . . C contact, even though the two Fe atoms in the base of the pyramidal Fe352 are chemically equivalent. The position of the apical Fe(CO)3, which is unusual with the arrangement, is known as an alternative confirmation. According to findings to date, however, the presence of an asymmetric carbon bridge also has to be assumed. The explanation for the unexpected behavior of [Fe352(CO)9] in the complex adduct is found high in the arrangement of the two components in the crystal. These are packed in such a way that the complexes are present, indeed like charge-transfer adducts.

FIG. 7 shows, in a perspective view, part of an alternating chain of trinuclear [Fe352(CO)9]- and dinuclear [Fe2(52) (CO)6]. When trinuclear [Fe352(CO)9]- and dinuclear [Fe2(52) (CO)6] alternating molecularly to 3.15 angstroms, intramolecular S—S bridges form to give infinite one-dimensional compounds. It is probably attributable to the disulfide group of the dinuclear complex and the resulting electron deficiency [Fe352(CO)9] and is compensated for by the asymmetric carbon bridge converted to an electron density into a thetrinuclear component. This explains why the simultaneously occurring Mössbauer spectrum of [Fe352 (CO) 9][(Fe2 (52) (CO) 6] differs significantly from that of the isolated complexes.

[Mn3Se2(CO)9]2 compared to [Mn3Se2(SeMe3) (CO)9]2

What is observed—in the [Mn2(CO)10]/Na25e/[Ph4P]Cl system—is the promotion of the reaction [Mn35e2(CO)9]2-( ) [Mn35e2(5eMe3) (CO)9]2. This complex is formed in methanol, in a formal sense, by the addition of a methaneselenolate ligand and the removal of an electron from the manganese structure. Here, the my-2-5eMe3 bridge is attached between Mn(1) and Mn(3). (3) For the asymmetric carbon bridge between Mn(2) and Mn.

FIG. 8 shows, in a perspective view, the superimposition of the structures of [Mn3Se2(CO)9]2- (shown in bold) and [Mn3Se2(SeMe3) (CO)9]2- (shown as a dotted line) (9), which form a complete 2-my carbon bridge, and illustrates these differences. The position of the carbon ligands relative to Mn(1) and Mn(2) changes only slightly, while Mn(3) has an octahedral coordination which of two clamps CO ligands, the 2-my carbon bridge, composed of 2 my-SeMe3 bridges and the two my-3-selenide ligands.

The introduction of the 2-my-SeMe3 bridges and the associated change in the geometry, i.e. the formation, could be reinforced by magnetic holding forces. The complex is diamagnetic 9a with its even number of 50 valence electrons. While the complex ion 9a with its odd number of valence electrons shows the expected paramagnetism (=1.8 myB for myeff [Mn3Se2(CO)9)2]2- at 100 K). This is also reflected in the considerable scatter of the phenyl resonances in the 1H NMR spectrum.

FIG. 9 shows, in diagrammatic form, the 1H NMR absorption characteristics of Ph protons in [Ph4P]2[Mn3Se2(CO)9] (in the left-hand part A of the figure) and [Ph4P]2[Mn3Se2(CO)9] (in the right-hand part B of the figure). These Heusler alloys frequently undergo a martensitic transition between the martensitic and austenitic phases, which generally takes place because of temperature induction and is a first-order transition. Ni2MnGa arrangements are ferromagnetic with a Curie temperature of 376 K and a magnetic moment of 4.17 IIB which is substantially restricted to the Mn atoms and is associated with the Ni atoms with a small moment of about 0.3 ILB. As can be expected from its cubic structure, the original phase has low magnetocrystalline anisotropy energy (Ha=0.15 T). However, in its martensitic phase, the compound has much greater anisotropy (Ha=0.8 T).

The martensite transition temperature is close to 220 K. This martensitic transition temperature can easily be varied to about room temperature by altering the composition of the alloy toward a stoichiometric alloy. The low-temperature phase develops from the starting phase by a diffusionless, position-changing transformation to a tetragonal structure, a=b=5.90 A, c=5.44 A. A martensite phase generally absorbs the root in association with the transformation (i.e. 6.56% of c for Ni2MnGa), through the formation of twin variants.

This means that a cubic crystal divides into two tetragonal crystallites which share a plane of contact. These twin species are packed together in appropriate orientations in order to the tension energy (similarly to the magnetization of a ferromagnet to different orientations through breakup into domains in order to minimize the magnetostatic energy). The alignment of these twin variants through the movement of the twin boundaries leads to large macroscopic roots.

In the tetragonal phase with relatively high magnetic anisotropy, an applied magnetic field can cause a change in expansion, which is the reason why these materials can be used as actuators. As well as this ferromagnetic shape memory effect, an observation that can be made very close to the martensitic transition temperature is that a great change in magnetization is present for low applied magnetic fields. This change in magnetization is likewise based on the magnetocrystalline anisotropy.

This change in the magnetization, which leads to a moderate magnetic change in entropy of a few J/molK, is amplified when implemented in a single crystal. When the composition in this material is present in such a way that the magnetic and structural transformation is effected at the same temperature and is matched to the greatest magnetic entropy, changes are observed.

For the magnetic applications, extremely large changes in length in the martensitic transition will lead to an aging effect. It is known that, in the case of magnetic shape memory alloys, frequently only single crystals are run, whereas polycrystalline materials spontaneously pulverize after a number of cycles. The temperature effects resulting from pressure on the crystalline formations can also be enhanced, but aging effects and declination of the polycrystalline species are often also observed.

Fe2P-based compounds offer the possibility of prevention of ionization processes; the binary intermetallic compound Fe2Ph can be considered as a base alloy for a practicable mixture of materials. This compound crystallizes in the hexagonal, non-point-symmetric FeMn-phosphorus compound, and has all positive properties for use as a transponder for domestic cooling systems.

Substitutions of Fe and/or Mn are conceivable with AS, Zi, Ni, Ge, Si. Fe occupies the 3g and 3f sides, and p the 1b and 2c sides. This results in stacking of alternating P-rich and -deficient P layers. Neutron diffraction shows that the magnetic moment of Fe on the 3g side is about 2 my-B, while the moment on the 3f side is about 1 my-B. The hexagonal form has poorer opportunities for being recovered as a magnetic source as a result of the aging.

A significant cause of the electrically conductive properties of the PET fibers as a result of the doping is that, in the dielectric carrier structure of the polyester, the metal particles are spatially separated from one another, but the electron clouds of the metal particles overlap with one another. The embedding of the doping elements into the polyester prevents breakdown processes and prevents external influences.

More particularly, reoxidation and frictional breakdown are prevented and flexibility is improved.

With regard to the radiation, it is possible to achieve exactly fixed, sharply delimited and reproducible frequency responses.

More particularly, it is possible with regard to the emission of radiation, by means of suitable doping, through the generation of infrared radiation in the frequency range from 4.5 μm to 11.5 μm to achieve.

As an alternative to the use of fibers of PET, it is also possible to use aramids. The fibers can be produced electrospinning methods.

A typical diameter of the fibers is in the range of 2 μm to 6 μm. The doping with the metal particles is preferably effected in a gas plasma.

A typical fiber length is in the range from 2 cm to 4 cm.

Suitable doping elements are especially the chemical elements which follow, either in the pure state or as an alloy. Particular consideration is given to the use of rare earth metals. Usable examples in that case also include iron, manganese, phosphorus, silicon, lanthanum, germanium, sodium, zinc, fluorine or arsenic. Additionally usable are also aluminum, copper and nickel.

Consideration is likewise given to the use of earth metals or alkali elements, for example of magnesium, calcium, sodium or potassium.

1-15. (canceled)

16. An electrically conductive polymeric fiber, comprising: a base material composed of PET; and elements embedding in the base material, wherein the elements have an atomic size and are spaced apart such that electron clouds of the elements have at least some regions of overlap.

17. The fiber according to claim 16, wherein. the elements have current-conducting properties, such that the fiber is at least partly electrically conductive.

18. The fiber according to claim 16, wherein the elements have magnetocaloric effects, such that the fiber is subject to an increase in temperature, at least in part, through action of a magnetic field,

19. The fiber according to claim 16, wherein the elements within the PET base material are present in an uneven density distribution.

20. The fiber according to claim 19, wherein the elements in material cross-sectional regions with a current displacement effect are in a less dense arrangement than in material cross-sectional regions with a current crowding effect.

21. The fiber according to claim 19, wherein the elements in near-surface material cross-sectional regions of an equivalent conductor layer thickness δ are induced a in a higher density than outside this region.

22. The fiber according to claim 16, wherein the elements are introduced into the PET base material by doping

23. The fiber according to claim 16, wherein the elements are formed by MnFe-phosphorus compounds.

24. The fiber according to claim 16, wherein the elements are formed by MnFe(As,PwGexSiz)s.

25. The fiber according to claim 24, wherein the elements have the following value: x=0.3-0.7 and, or w not less than 1−x and z=1−x−w.

26. The fiber according to claim 16, wherein the elements are formed by MnFe-phosphorus compounds with As,Si-phosphorus substitution and in combination with La(FeMnP)AlCo.

27. The fiber according to claim 16, wherein the elements are formed by compounds comprising Mn—Zn. (New) The fiber according to claim 16, wherein the elements are formed by an alloy comprising FeMnP0.7Ge0.3.

29. The fiber according to claim 16, wherein the elements are formed by an alloy comprising FeMnP0.5Ge0.5.

30. An absorber material according to claim 16, wherein the elements are formed by an alloy comprising Fe0.86Mn1.14P0.5Si0.35Ge0.15.
